(19) United States
(12) Patent Application Publication
(10) Pub. No.: US 2006/0249872 A1
(43) Pub. Date: Nov. 9, 2006

(54) Compound mold tooling for controlled heat transfer

(76) Inventors: Mark Manuel, Shelby Township, MI (US); Matt Lowney, Davisburg, MI (US); Thomas Greaves, Rochester Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/484,475

(22) Filed: Jul. 11, 2006

Related U.S. Application Data
(63) Continuation-in-part of application No. 11/037,615, filed on Jan. 18, 2005.
(63) Continuation-in-part of application No. 11/233,708, filed on Sep. 23, 2005.

(51) Int. Cl. B29C 33/40; E04B 1/16; B29C 67/00

(52) U.S. Cl. 264/225; 264/35; 264/219

(57) ABSTRACT

A tool is provided for forming an article in a molding operation with a body formed with a forming surface for forming the article. A heat transfer material is mounted to the tool body, spaced apart from the forming surface, and formed from a material having a coefficient of thermal conductivity that is greater than that of the tool body. The heat transfer material and/or the tool body collectively provide a duct for conveying a fluid for heat transfer with the forming surface. Another tool is disclosed for forming an article in a molding operation with a tool body formed from a plurality of laminate sheets of a first material. The tool body includes a forming surface and a cavity. A heat transfer material having a coefficient of thermal conductivity greater than that of the first material is disposed within the cavity for transferring heat from the forming surface.

### CROSS-REFERENCE TO RELATED APPLICATIONS

This application is a continuation-in-part of U.S. application Ser. No. 11/037,615 filed Jan. 18, 2005, pending; and this application is a continuation-in-part of U.S. application Ser. No. 11/233,708 filed Sept. 23, 2005, pending; the disclosure of these applications are incorporated in their entirety by reference herein.

### BACKGROUND OF THE INVENTION

1. Field of the Invention

The invention relates to tools for molding articles, more particularly to tools that incorporate cooling into the forming of the articles.

2. Background Art

The prior art provides various tools for forming articles, by various forming processes, such as injection molding, blow molding, reaction injection molding, die casting, stamping and the like. These tools often utilize a first mold half and a second mold half, each having opposing forming surfaces for collectively forming an article therebetween. The mold halves are often formed separately, and one half translates relative to the other for closing, forming the article, opening, removing the article and repeating these steps.

Often, mold halves are each formed from a solid block of material that is capable of withstanding the stresses, pressures, impacts and other fatigue associated with the associated forming processes. Various forming processes involve heating the material of the article in order to mold the article to the forming surfaces of the mold halves. Often times, one or more of the mold halves are cooled in order to enhance the rate of solidification of the material of the article and to reduce the cycle time of the molding process. A mold half is often cooled by fluid this is formed through a fluid line in the mold half. Fluid lines are often provided within molds or mold halves by drilling a fluid line through the solid mold block.

### SUMMARY OF THE INVENTION

A first embodiment of the present invention provides a tool for forming an article in a molding operation with a tool body formed from a first material with a forming surface for forming the article. A heat transfer material is mounted to the tool body, spaced apart from the forming surface, and the heat transfer material has a coefficient of thermal conductivity that is greater than that of the first material. The heat transfer material or the heat transfer material and the tool body collectively provide a duct for conveying a fluid for a transfer of heat between the fluid and the forming surface, through the tool body and the heat transfer material during a molding operation.

A second embodiment of the present invention provides a tool for forming an article in a molding operation with a tool body formed from a plurality of laminate sheets of a first material. The laminate sheets are shaped to collectively form a forming surface for forming the article, and at least one of the plurality of laminate sheets is shaped to form a cavity in the tool body that is spaced apart from the forming surface. A heat transfer material that has a coefficient of thermal conductivity greater than that of the first material is disposed within the cavity for a transfer of heat from the forming surface to the heat transfer material, through the tool body during a molding operation.

A third embodiment of the present invention provides a method for forming a molding tool wherein a tool body is provided from a first material with a forming surface for forming an article in a molding operation. A heat transfer region is cast to the tool body for a transfer of heat between the forming surface and the heat transfer region during a molding operation. The heat transfer region is cast from a second material having a coefficient of thermal conductivity that is greater than that of the first material and a melting temperature that is less than that of the first material.

A fourth embodiment of the present invention provides a method for forming a molding tool wherein a tool body is formed from a plurality of laminate sheets of a first material to collectively form a forming surface for forming an article, and to collectively form a cavity in the tool body that is spaced apart from the forming surface. A heat transfer material is disposed within the cavity for transfer of heat between the forming surface and the heat transfer material through the tool body during a molding operation. The heat transfer material has a coefficient of thermal conductivity that is greater than that of the first material.

The above embodiments, and other embodiments, aspects, objects, features, and advantages of the present invention are readily apparent from the following detailed description of embodiments of the invention when taken in connection with the accompanying drawings.

### BRIEF DESCRIPTION OF THE DRAWINGS

FIG. 1 is a perspective view of a tool in accordance with the present invention;

FIG. 2 is a section view of the tool of FIG. 1, taken along section line 2-2;

FIG. 3 is a section view of another tool in accordance with the present invention;

FIG. 4 is an exploded, partial section view of a tool in accordance with the present invention;

FIG. 5 is a section view of the tool of FIG. 4, illustrated partially assembled;

FIG. 6 is a section view of the tool of FIG. 4, illustrated after a manufacturing process;

FIG. 7 is an exploded, partial section view of another tool in accordance with the present invention;

FIG. 8 is a section view of the tool of FIG. 7, illustrated partially assembled;

FIG. 9 is a section view of another tool in accordance with the present invention;

FIG. 10 is a section view of the tool of FIG. 9, illustrated after a manufacturing process;

FIG. 11 is a fragmentary perspective view of a portion of a tool in accordance with the present invention;

FIG. 12 is another perspective view of the portion of the tool of FIG. 8;

FIG. 13 is a perspective view of a sectioned tool in accordance with the present invention;

FIG. 14 is an elevation view of another sectioned tool in accordance with the present invention;

FIG. 15 is a perspective view of yet another sectioned tool in accordance with the present invention;

FIG. 16 is a perspective view of another tool in accordance with the present invention;

FIG. 17 is another perspective view of the tool of FIG. 16;

FIG. 18 is a partial section view of the tool of FIG. 16; and

FIG. 19 is another partial section view of the tool of FIG. 16.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

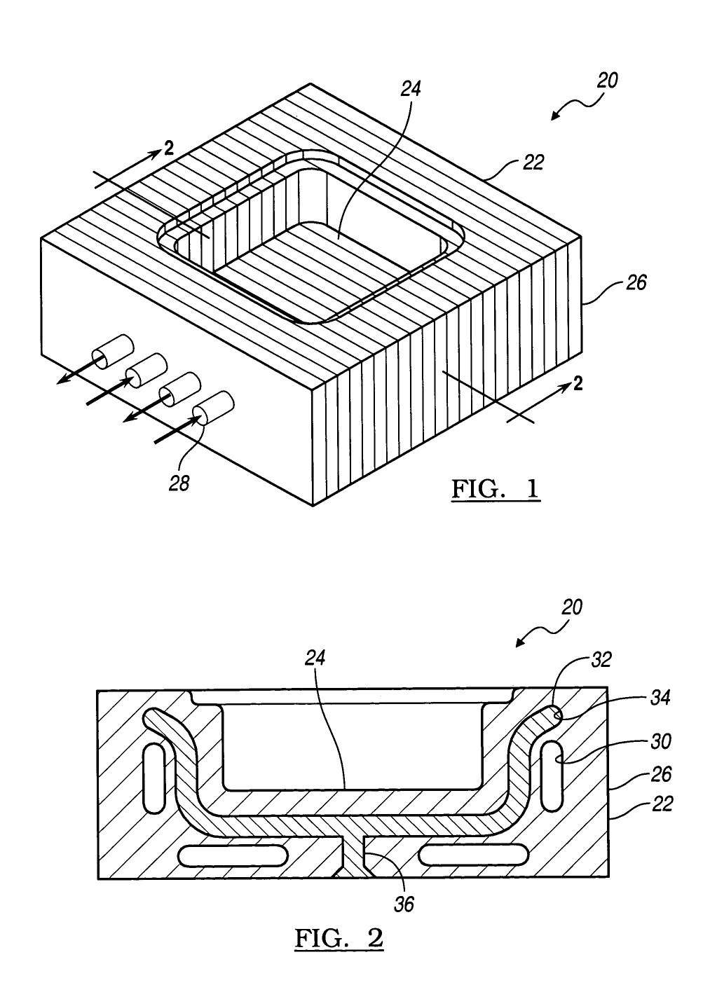

With reference now to FIG. 1, a tool is illustrated in accordance with the present invention and is referenced generally by numeral 20. The tool 20 is a tool for forming an article in a molding operation, such as injection molding, blow molding, reaction injection molding, roto-molding, die casting, stamping or the like. Alternatively, the tool may be a mandrel that is shaped similar to the article for forming a molding tool, a die casting tool, a stamping tool or the like, which is then employed for forming the article. Although one tool 20 is illustrated, the invention contemplates the tool 20 may be a mold member, which is utilized in combination with one or more mold members, such as an opposed mold half for forming an article collectively therebetween.

The tool 20 includes a tool body 22, which has a forming surface 24 for forming the article. The tool body 22 may be formed from a solid block that is roughly machined to a near net shape. Alternatively, the tool body 22 may be formed from a multiple layer process, for example, a laminate process, such as that disclosed in U.S. Pat. No. 6,587,742 B2, which issued on Jul. 1, 2003 to Manuel et al.; U.S. Pat. No. 5,031,483, which issued on Jul. 16, 1991 to Weaver; and U.S. Published Patent Application 2005/0103427 A1, which published on May 16, 2005 to Manuel et al.; the disclosures of which are incorporated in their entirety by reference herein.

As illustrated, the tool body 22 may be provided by a series of laminate plates 26. The tool 20 may be equipped with a series of fluid lines 28 for conveying fluid through the tool 20 for heating or cooling the forming surface 24. For example, the tool body 22 may be formed of a material such as stainless steel, which has limited conductivity. In order to control heating and/or cooling of a part formed by the tool 20, a rate of heat transfer of the working surface 24 may be enhanced and controlled by conveying fluid through the fluid lines 28. For example, a heated fluid, such as heated oil may be pumped through fluid lines 28 to heat the working surface 24 to a pre-defined temperature for maintaining a temperature of a material within the tool 20, such as a polymeric material in an injection molding process. Likewise, coolant may be conveyed through the fluid lines 28 for cooling the working surface 24 thereby solidifying the material of the article formed by the tool 20. Such controlled coolant is utilized for providing uniform heating and/or cooling of an article formed within the tool 20. The controlled rates of heat transfer can be employed for limiting internal stresses of a resultant product and limiting sink, shrink and warpage of the product. Such control consequently enhances an overall quality of the resulting product. Additionally, the cycle time may be reduced for improving the output volume of components by the particular tool 20.

Referring now to FIG. 2, the tool 20 is illustrated sectioned along section line 2-2 for revealing ducts 30 formed within the tool body 22. The ducts 30 are segments of the fluid lines 28 and are shaped to provide conformal cooling to the forming surface 24 of the tool body 22. The ducts 30 may be cut into the laminate sheets 26 individually for collectively providing paths of fluid flow for fluid within the cooling lines 28. The ends of the fluid lines 28 may be capped with a fitting for coupling a fluid source to the tool 20.

A conductive material 32 may be disposed between the forming surface 24 and the ducts 30 through the tool body 20 for enhancing the rate of the heat transfer between the forming surface 24 and the ducts 30. Since the tool 20 illustrated in FIGS. 1 and 2 has been formed by a multilayer process of laminate sheets 26, the conductive material 32 may be provided in a shape that is contoured to match a contour of the forming surface 24 of the tool 20. The conductive material 32 may be a material such as copper that has an enhanced coefficient of thermal conductivity relative to the structural material utilized for the tool body 22. The tool body 22 may be designed to withstand stresses, pressures and fatigue associated with the forming process of the tool body 22, and the conductive material 30 may be designed for conducting heat from the work surface 24 to the ducts 30, or from the ducts 30 to the forming surface 24.

The conductive material 32 may be provided by laminate or foil sheets of conductive material 32 that are disposed within the laminate sheets 26 of the tool body 22. Alternatively, the conductive material 32 may be cast into the tool body 22 into a cavity 34 formed within the tool body 22, or formed through multiple laminate sheets 26 of the tool body 22. Accordingly, a runner 36 may be provided within the cavity 34 for permitting the conductive material 32 to seep into the cavity 34. Alternatively, the conductive material 32 may be permitted to pass through tolerance gaps between the laminate sheets 26 by capillary action. In order to prevent the conductive material 32 from seeping into the ducts 30, tubing may be placed into the ducts 30 during assembly of the tool body 22. Alternatively, a particulate material, such as sand, may be provided within the ducts 30 during the casting process to prevent the conductive material 32 from seeping into the ducts. The particulate material may be subsequently removed by vibration of the tool 20, imparting fluid into the fluid lines 28, submersion of the tool 20 within the fluid, or by any suitable particulate material removal process.

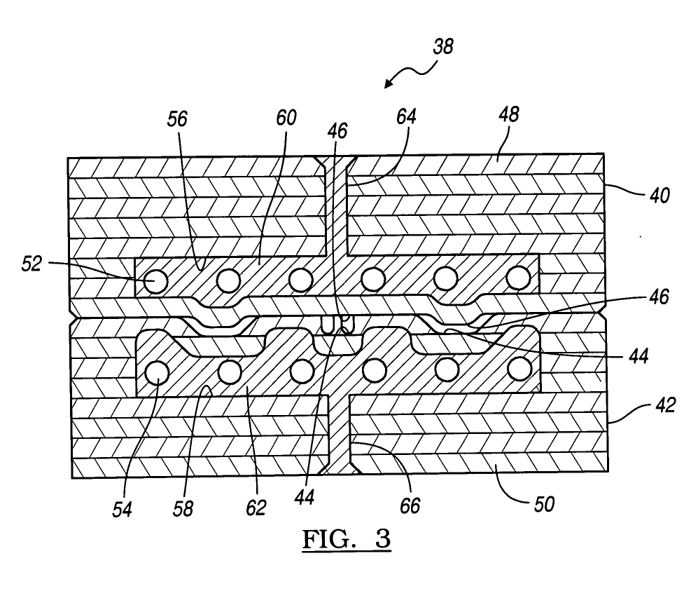

Referring now to FIG. 3, another tool 38 is illustrated in accordance with the present invention. The tool 38 includes an upper die 40 and a lower die 42 for forming an article within the dies 40, 42. Each of the dies 40, 42 include cooperating forming surfaces 44, 46 for receipt of a material, such as injection molded plastic for molding a component. For example, if the tool 38 is for molding plastic outlet covers, the section view is illustrated bisecting the plate between outlet apertures. The section view of FIG. 3 also illustrates outboard lateral regions of the outlet cover with a tapered profile, and a central configuration for providing a fastener aperture centrally through the plate cover. Of course various formed articles are contemplated within the spirit and scope of the present invention.

Similar to the prior embodiment of FIGS. 1 and 2, the dies 40, 42 may be formed from laminate sheets 48, 50 respectively. Similar to the prior embodiment, each die 40, 42 may include a series of fluid lines 52, 54 extending through the die 40, 42 for conveying fluid through the dies 40, 42. The fluid lines 52, 54 may be embodied by tubing that is placed within a cavity 56, 58 within each die 40, 42. After the dies 40, 42 are assembled with the laminate sheets 48, 50 and the corresponding fluid lines 52, 54, heat sinks 60, 62 may be disposed within each die 40, 42 by a conductive material that is spaced apart from the corresponding forming surfaces 44, 46. The heat sinks may also be in contact with the respective fluid lines 52, 54 as illustrated in FIG. 3. The heat sinks 60, 62 may be utilized for conducting heat to and/or from the forming surfaces 44, 46 to the fluid within the fluid lines 52, 54.

Similar to the prior embodiment, the heat sinks 60, 62 may be cast into the dies 40, 42 and runners 64, 66 may be provided for permitting the conductive material to seep into the cavities 56, 58.

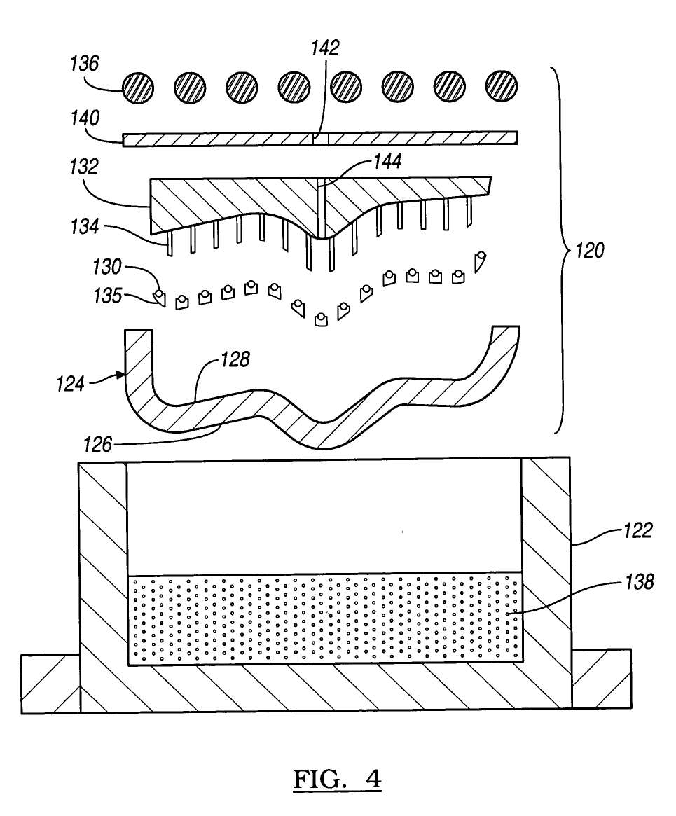

With reference now to FIG. 4, a tool is illustrated in accordance with the present invention; the tool is illustrated exploded and is referenced generally by numeral 120. The tool 120 is a tool for forming an article in a molding operation, such as injection molding, blow molding, reaction injection molding, die casting, stamping or the like. The tool 120 is illustrated exploded and oriented relative to a carrier box 122, which is utilized in the forming of the tool 120. Although one tool 120 is illustrated, the invention contemplates the tool 120 may be a mold half, which is utilized in combination with one or more mold components, such as an opposed mold half for forming an article therebetween.

The tool 120 includes a tool body 124, which has a forming surface 126 for forming the article. The tool body 124 may be formed from a solid block that is roughly machined to a near net shape. Alternatively, the tool body 124 may be formed from a multiple layer process, for example, a laminate process, such as that disclosed in U.S. Pat. No. 6,587,742 B2; U.S. Pat. No. 5,031,483; and U.S. Published Patent Application 2005/0103427 A1.

The tool body 124 is provided with an open back surface 128, which is adequately spaced from the forming surface 126 so that the tool body 124 can structurally support the forming surface 126, while providing access at the back surface 128 for fluid lines 130 for heating or cooling of the forming surface 126. The back surface 128 is illustrated recessed within the tool body 124, however the invention contemplates that the tool body 124 may have a back surface 128 that is not recessed within the tool body 124. The thickness between the back surface 128 and the forming surface 126 is determined by the necessitated structural integrity of the tool body 124 and the desired rate of heat transfer provided by the fluid lines 130. The structural integrity, and the rate of heat transfer may be predetermined via conventional mechanics and heat transfer calculations, finite element analysis, or the like, and these design criteria may be specific for each molding application.

If the back surface 128 of the tool body 124 is provided in a recess as illustrated for the embodiment of FIG. 4, the recess may be formed into a solid block, which provides the tool body 124, or the recess may be formed collectively through laminate sheets.

The tool body 124 is provided by a material that is adequate for performing the forming or molding operation of the associated article. For example, the tool body 124 may be formed from a solid tool steel or stainless steel, or the tool body may be formed from laminate sheets such as American Iron and Steel Institute (AISI) designations of 410 stainless steel, 4130 stainless steel, H13 stainless steel, S7 tool steel, P2 tool steel, various aluminum alloys, combinations thereof, or the like.

The tool body 124 may include a tool body insert 132 for added structural support through the tool body 124. The tool body insert 132 may be provided within the recess of the back surface 128 and may engage the tool body 124 directly or may include a series of supports 134 extending from the insert 132 for engagement with the back surface 128 of the tool body 124. The tool body insert 132 may be formed unitarily from a solid block, or from multiple components such as laminate sheets.

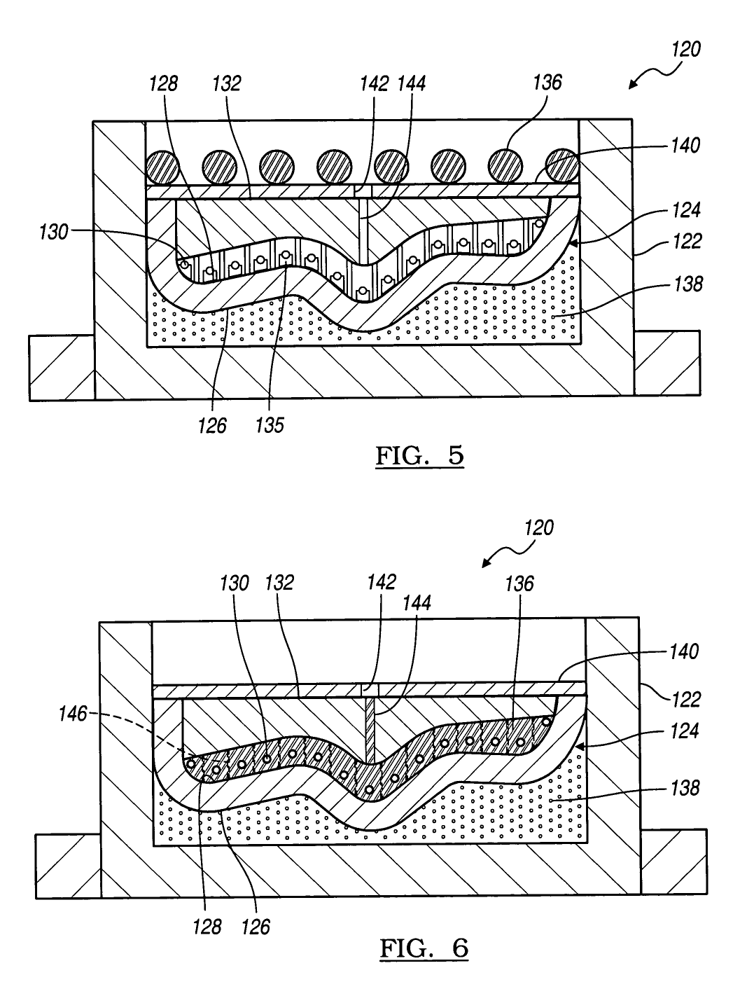

With reference now to FIGS. 4 and 5, the fluid lines 130 are provided on the back surface 128 of the tool body 124. The fluid lines 130 may be spaced incrementally from the back surface 128 by spacer blocks 135 which may be rested upon the back surface 128 or affixed to the back surface 128. The fluid lines 130 are arranged to conform to a contour of the forming surface 126 due to the arrangement of the fluid lines 130 relative to the forming surface 126. The fluid lines 130 may include a single fluid line or multiple fluid lines 130 for cooling and heating the forming surface. Unlike prior art cooling methods, wherein fluid lines are drilled into the tool body, the conformal fluid lines 130 conform to the shape of the forming surface 126 and may provide uniform and controlled heating and/or cooling of the forming surface 126 of the tool body 124.

As illustrated in FIG. 5, the fluid lines 130 and spacer blocks 135 are arranged upon the back surface 128 of the tool body 124. In order to enhance the heat transfer of heat to and from the forming surface 126, a conductive material 136 is provided for cooperation with the back surface 128 of the tool body 124 and with the fluid lines 130. For the illustrated embodiment, the conductive material 136 is cast to the tool body 124 and the fluid lines 130. The conductive material 136 may be any material having a coefficient of thermal conductivity greater than that of the tool body 124. For example, the conductive material 136 may be copper, which has a coefficient of thermal conductivity of 390 W/m·K (Watts per meter·Kelvin), which is greater than that of aluminum which has a conductivity of 360 W/m·K, and tool steel, which has a coefficient of thermal conductivity of 25-35 W/m·K.

One exemplary method for casting the conductive material 136 into the tool body 124, involves placement of the tool body 124 into the carrier box 122. The carrier box 122 may be a custom or reuseable box for transporting the tool 120 to a kiln or furnace for heating the tool 120 during the casting operation. The carrier box 122 is configured for receiving and supporting the tool body 124. In the embodiment illustrated, the carrier box 122 is provided with a particulate material 138 having a melting temperature greater than that of the conductive material 136. The particulate material 138 may be any particulate material commonly utilized in casting operations such as sand, zircon (zirconium silicate), a ceramic fiber, (such as Fiberfrax® provided by Unifrax Corporation of Niagra Falls New York) or the like.

In addition to supporting the tool body 124 during the casting operation, the particulate material 138 bounds an outer region of the tool body 124 such that the cast conductive material 136 may not flow past the tool body 124. For example, if the tool body 124 was formed from a plurality of laminate sheets with minimal gaps therebetween due to tolerances of the sheets, the particulate material 138 provides an external barrier to the tool body 124 such that the conductive material 136 may not flow past the boundary of the particulate material 138. Once the tool body 124 is inserted into the carrier box 122 the carrier box 122 may be vibrated until the tool body 124 is substantially immersed within the particulate material 138.

The conductive material 136 may be placed on the back of the tool body 124 or the tool body insert 132. The conductive material 136 may be provided as raw pieces of conductive material, such as bars or slabs. Depending on the quantity of conductive material 136 required, the weight of the conductive material 136 may exceed a load capacity of the back surface 128 of the tool body 124 or the tool body insert 132. Accordingly, a support plate 140 may be provided for uniformly distributing the weight of the conductive material 136 across the back of the tool body 124 and tool body insert 132. Alternatively, the support plate 140 may be supported by the carrier box 122 by mechanical fasteners, or the support plate 140 may be welded directly to the carrier box 122. Once the support plate 140 is mounted to the carrier box 122, the bars of conductive material 136 may be placed upon the support plate 140 within the carrier box 122, as illustrated in FIG. 5. Alternatively, the support plate 140 may be fastened to the tool body 124 for utilization as a mounting plate in the associated molding machine.

Once the tool 120 is assembled within the carrier box 122, as illustrated in FIG. 5, the carrier box 122 is placed within a kiln, furnace or the like. The conductive material 136 has a melting temperature less than that of the tool body 124 and the particulate matter 138. The fluid lines 130 are either formed from a material having a melting temperature greater than that of the conductive material 136, or are filled with a particulate material that has a melting temperature greater than that of the conductive material 136 for maintaining the fluid lines 130 after the casting process. For example, the fluid lines 130 may be formed from corrugated flexible stainless steel pipe and/or may be filled with sand for maintaining the fluid lines 130 through the conductive material 136 after the casting operation.

During the casting operation, the tool 120 is heated to a temperature greater than the melting temperature of the conductive material 136. For example, if a conductive material 136 of copper is utilized, copper has a melting temperature of 1992 degrees Fahrenheit and therefore the tool 120 must be heated to a temperature greater than 1992 degrees Fahrenheit, for example 2050 degrees Fahrenheit. The support plate 140, if utilized for the particular embodiment, may be provided with an aperture 142 so that the conductive material 136 may melt and flow through the aperture 142 to the back surface 128 of the tool body 124. If a tool body insert 132 is utilized for the particular embodiment, or if the conductive material 136 is rested upon the tool body 124, an aperture 144 may also be formed through the tool body insert 132 or the tool body 124 so that the conductive material 136 may flow to the back surface 128 of the tool body 124.

An ideal volume of conductive material 136 is placed within the carrier box 122 to fill the volume provided adjacent the back surface 128 of the tool body 124. Referring to FIG. 6, after the conductive material 136 has melted and the conductive material 136 has flowed into engagement with the back surface 128 of the tool body 124 and the fluid lines 130, the tool 120 is cooled so that the conductive material 136 may solidify.

During various forming operations, such as injection molding, the forming surface 126 of the tool body 124 is heated and cooled for each part formed by the particular tool. In order to uniformly control heating and cooling of the tool body 124, the fluid lines 130 may be connected to a source of pressurized fluid, such as a coolant pump and a a pump for heated oil. In order to further facilitate heat transfer between the forming surface 126 and the fluid lines 130, the back surface 128 of the tool body 124 and the fluid lines 130 are in contact with the conductive material 136, which is cast to the back surface 128 of the tool body 124 and cast about the fluid lines 130. Thus, internal stresses of articles formed by the tool 120 can be controlled, reduced or eliminated; shrink, sink and warpage of the molded article can be controlled; and cycle time can be improved due to the enhanced heating and cooling engagement of the fluid lines 130 and the forming surface 126 through the conductive material 136. Additionally, much flexibility is provided in the arrangement of the fluid lines 130, permitting the fluid lines 130 to be conformed to the contour of the back surface 128 of the tool body 124 thereby matching the forming surface 126 for improved conformal fluid cooling or fluid heating.

After the tool 120 is formed with the conductive material 136 cast to the back surface 128 of the tool body 124, the tool 120 may be removed from the carrier box 122 and may be vibrated to remove particulate matter 138 from the forming surface 126 of the tool body 124. Additionally, the tool 120 may be vibrated to remove particulate material 138 from within the fluid lines 130, if utilized.

The particular molding application for the tool 120 may require such large rates of heat transfer that the thermal expansion rates of the tool body 124 and the conductive material 136 conflict. Therefore, a series of gaps 146 is illustrated in phantom in FIG. 6, that may be provided through the conductive material 136 for permitting varying rates of thermal expansion of the conductive material 136 relative to that of the tool body 124. The gaps 146 may be formed during the casting operation by inserts of sand blocks or may be machined into the conductive material.

Many conductive materials have a substantial shrinkage rate as they solidify. For example, copper has a shrinkage rate of approximately five percent. To avoid the shrinkage from affecting the final tool, a riser may be incorporated into the back surface 128 of the tool at an orientation where heat transfer is unaffected for permitting the shrinkage to occur away from any critical heat transfer regions.

Alternatively, the carrier box 122 may be a temporary box, which may be fabricated from wood. A castable refractory material 138 such as a castable ceramic that is thermally conductive such as an alumina-silicate carbide may be utilized instead of sand or other particulate material. The refractory material 138 may be mixed with water and inserted into the carrier box 122. Subsequently, the tool body 124 may be inserted into the refractory material 138 thereby casting the refractory material 138 about the tool body 124. The refractory material 138 is permitted to dry and harden. To enhance the curing of the refractory material 138, the carrier box 122, refractory material 138, and tool body 124 may be placed in an oven and heated to a temperature greater that 250 degrees Fahrenheit to accelerate the evaporation of water from the refractory material.

Once the refractory material 138 is cured and hardened, the carrier box 122 may be removed from the cast refractory material 138 and tool body 124 and placed into a kiln or furnace for casting a conductive material 136 into the tool body 124 as described above. For example, a refractory material 138 such as an alumina-silicate carbide can withstand temperatures up to 3,400 degrees Fahrenheit. The refractory material 138 provides a thermal conductivity rate that is approximately twenty percent of the thermal conductivity rate of the tool body 124, and is greater than that of sand. The relatively high rate of heat transfer of the refractory material 138 ensures brazing of the conductive material 136 through the tool body 124, particularly to the forming surface, without requiring a prolonged dwell time. Accordingly, the cycle time of casting within the furnace is reduced and an adequate braze is provided through the tool body 124. Once the conductive material 136 is cast into the tool body 124, the tool body 124 may be cooled, and the refractory material 138 may be removed from the tool body 124 by destroying the cast refractory material 138.

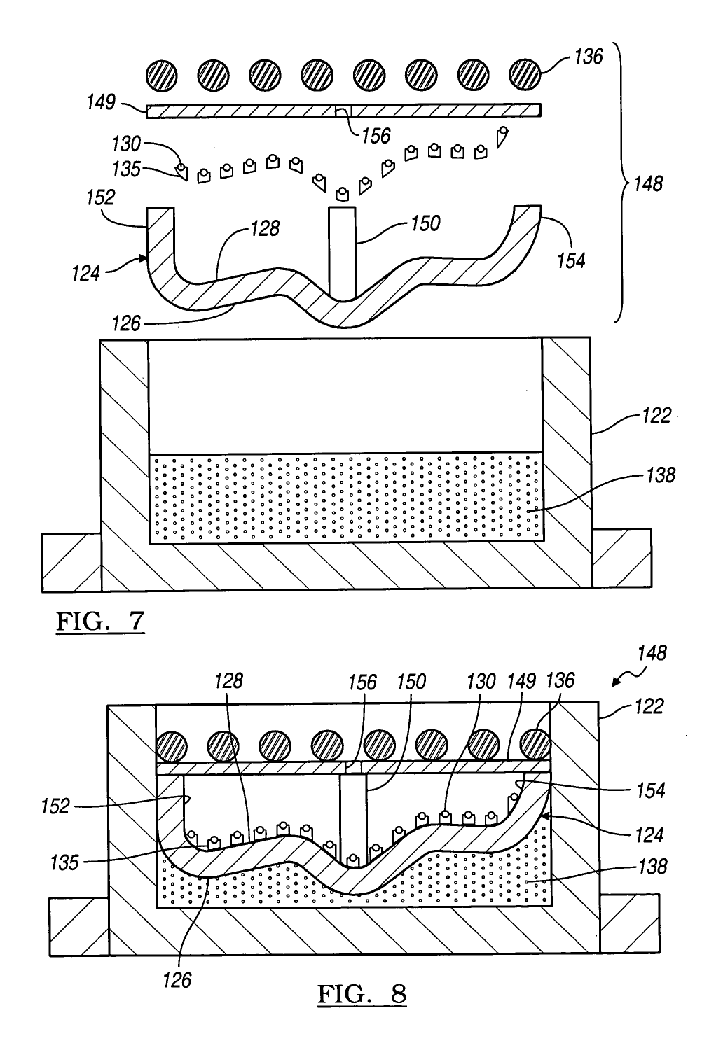

With reference now to FIGS. 7 and 8, another tool 148 for forming an article in a molding operation is illustrated in accordance with the present invention. Similar or same elements are assigned same reference numerals wherein new elements are assigned new reference numerals.

The tool 148 includes a tool body 124 with a forming surface 126 and a back surface 128. A plurality of fluid lines 130 are provided to be rested upon the back surface 128 of the tool body 124 upon spacer blocks 135. A mounting plate 149 is mounted directly to the tool body 124. Due to varying thermal expansion rates, the mounting plate 149 is fixed to the tool body 124 at only one location for permitting varying thermal expansion rates of the mounting plate 149 and the tool body 124. Accordingly, a central support 150 is provided on the back surface 128 of the tool body 124, which is fixed directly to the mounting plate 149. For example, the mounting plate 149 may be welded to the central support 150. Thus, the mounting plate 149 is supported by the central support 150 of the tool body 124 and, for example, distal ends 152, 154 of the tool body 124. This support arrangement supports the mounting plate 149 relative to the tool body 124 and permits linear translation of the distal ends 152, 154 relative to the central support 150 due to thermal expansion. Likewise, the tool body 124 may be supported by the mounting plate 149 by the central support 150 and distal ends 152, 154.

Referring now to FIG. 8, the support plate 149 also includes an aperture 156 formed therethrough, which is offset from the central support 150 for permitting the conductive material 136 to pass through the mounting plate 149 during the casting operation. Similar to the prior embodiment, the carrier box 122 may be placed in a furnace to melt the conductive material 136 and cast the conductive material 136 to the back surface 128 of the tool body 124.

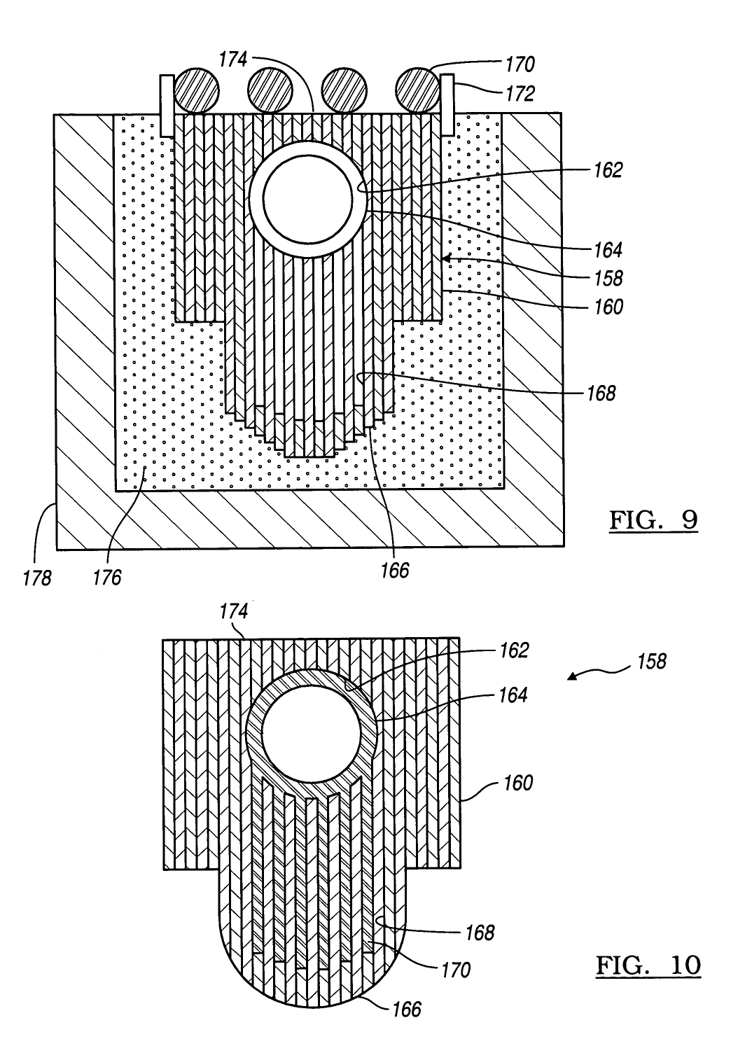

Referring to FIG. 9, another tool 158 for forming an article in a molding operation is illustrated in accordance with the present invention. The tool 158 is formed from a plurality of laminate sheets 160, by utilizing one of the plurality of methods for forming mold tools from laminate sheets, such as those disclosed in the Manuel U.S. Pat. No. 6,587,742 B2, the Weaver Pat. No. 5,031,483, or the Manuel et al. Published Application No. 2005/0103427 A1, or any other suitable laminate tooling process. The laminate sheets 160 may each be formed of a suitable material, such as stainless steel for performing the forming operation. The laminate sheets 160 may collectively provide a duct 162 formed through a plurality of the sheets 160 for conveying fluid. A tube 164 may be inserted within the duct 162 and may be filled with a particulate material, such as sand. Distal ends of the tube 164 may be plugged with a material having a high melting temperature, such as a Fiberfrax® plug for preventing a conductive material from infiltrating the tube 164.

The laminate sheets 160 collectively provide the shape of the tool 158 and may be assembled together by bolts, press fit projections, welds or the like. Projections for assembling adjacent laminate sheets are disclosed in U.S. Patent Application Publication No. 2005/0196232 A1, which published on Sept. 8, 2005 to Manuel et al., the disclosure of which is incorporation in its entirety by reference herein.

The laminate sheets 160 also provide a near net forming surface 166 on the tool 158. A plurality of cavities 168 are formed within the tool 158 by cutouts in selected laminate sheets 160. The cavities 168 may be formed intersecting the duct 162. The tool 158 may be assembled with a conductive material disposed within the cavities 168 of the laminate sheets 160. Alternatively, a conductive material 170, such as copper, may be cast into the cavities 168 of the tool 158. The conductive material 170 may be cast into the tool 158 in a similar manner disclosed in the prior embodiments of FIGS. 4-8. Alternatively, sidewalls 172 may be mounted directly to the tool 158 about a periphery of a back surface 174 of the tool for retaining slabs of the conductive material 170.

Although the cavities 168 are illustrated parallel with the laminate sheets 160, the invention contemplates that the laminate sheets 160 may be formed perpendicular to the laminate sheets 160.

The tool 158 may be placed within a particulate material 176 within a reuseable carrier box 178. The carrier box 178, particulate material 176 and tool 158 may be vibrated until the tool 158 is partially immersed within the particulate material 176. The conductive material 170 may be placed upon the back surface 174 of the tool 158. The conductive material 170 selected has a melting temperature less than that of the particulate material 176, the laminate sheet 160 of the tool 158, and any particulate material disposed within the duct 162 or the tube 164 within the duct 162 so that the conductive material 170 is the first and only thing to melt during the casting process.

Once assembled, the carrier box 178 is placed in a kiln, furnace or the like and is heated to a temperature greater than the melting temperature of the conductive material 170. An aperture may be formed within the tool 158 so that the conductive material 170 may flow through the aperture into the duct 162 and the cavity 168. Due to toleration variances in the laminate sheets 160, the conductive material 170 may seep between the gaps provided between adjacent laminate sheets 160 of the tool 158 through capillary action. Thus, the conductive material 170 may seep between the adjacent laminate sheets 160 and fill the cavities 168, and fill the duct 162 about the tube 164. Upon cooling of the tool 158, the conductive material 170 is disposed within the cavities 168 and surrounds the tube 164 within the duct 162. Additionally, the conductive material 170 brazes the laminate sheets 160 of the tool 158 together. The particulate material 176 provides a boundary to the casting process such that the conductive material 170 does not flow externally from the tool 158 past the particulate material 176.

As discussed above, with reference to FIGS. 5 and 6, the carrier box 178 of FIG. 9 may be temporary for casting a refractory material 176 about the tool 158. Then the carrier box 178 may be removed and the conductive material 170 may be cast into the tool 158. After the tool 158 is cooled, the refractory material 176 may be shattered and removed from the tool 158.

With reference now to FIG. 10, the tool 158 is illustrated with each of the cavities 168 filled with the conductive material 170. Additionally, the conductive material 170 has surrounded the tube 164 and the duct 162. Further still, the conductive material 170 has brazed the individual laminate sheets 160 of the tool 158 together. The forming surface 166 of the tool 158 is illustrated after a machining process. During a molding operation, the conductive material 170 and the cavities 168 conduct heat from the forming surface 166 to the tube 164 for heating fluid therein as the fluid is passed through the tube 164. Likewise, when the forming surface 166 requires an increase in heat, a heated fluid may be pumped through the tube 164 so that heat is conducted through the conductive material 170 to the forming surface 166.

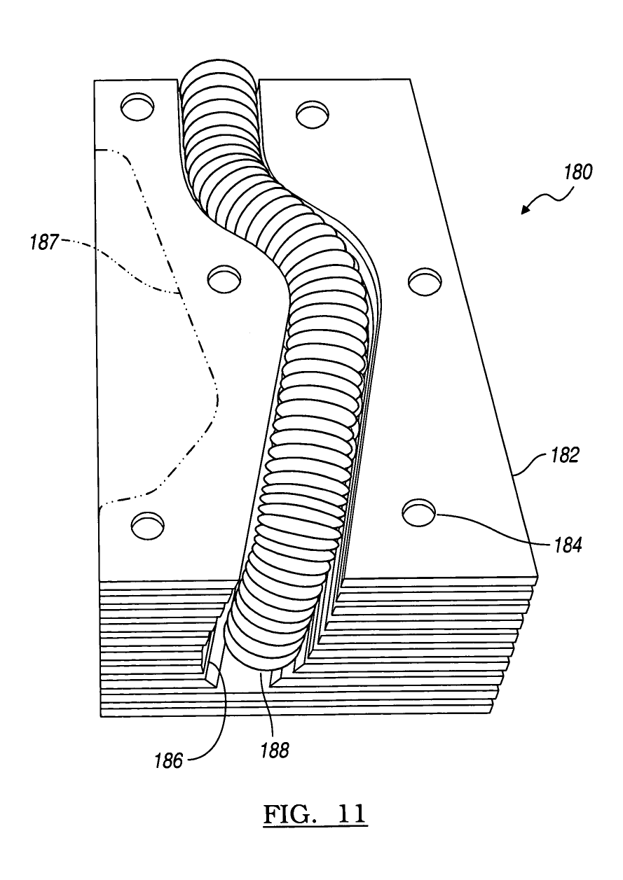

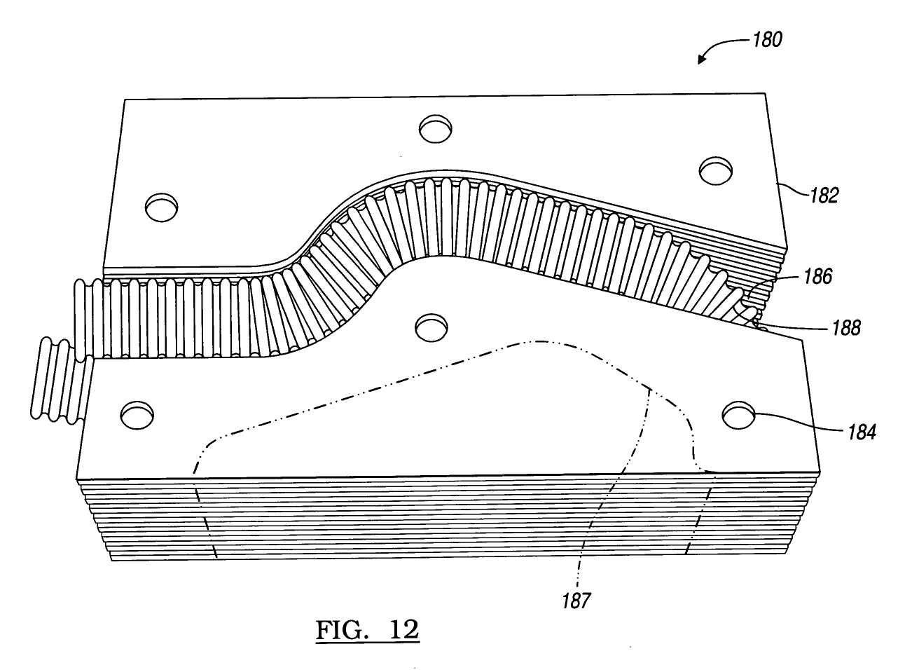

Referring now to FIGS. 11 and 12, a portion of a tool 180 is illustrated in accordance with the present invention. The tool 180 is formed from a series of laminate sheets 182 secured together by a series of press fit projections 184 for adjoining adjacent laminate plates. A plurality of the laminate sheets 182 each include a cutout formed therein to collectively provide a duct 186 for passage of coolant or heated fluid for cooling or heating a forming surface of the tool 180. The duct 186 is illustrated spaced apart from a forming surface 187 (illustrated in phantom) which may be cut into the sheets 182 collectively with the duct 186, or subsequently in a machining operation.

A flexible tube 188 is illustrated disposed within the duct 186 for conformally cooling or conformally heating the tool 180. The flexible tube 188 may be a corrugated stainless steel tube with a wall thickness of 0.02 inches. The flexible tube 188 may be oxidized to prevent the molten conductive material from burning through the tube 188. Alternatively, the tube 188 may be filled with a limiter such as sand. The corrugated tube 188 provides flexibility to the tube and also causes turbulence to fluid forced therethrough for enhanced heat transfer from the tube 188 to the fluid passing therethrough. Of course, the flexible tube 188 may be formed from any suitable material, such as brass which may melt with the conductive material and form integrally therein about a limiter provided within the tube 188, such as sand.

Various arrangements and configurations of ducts, arrangements of conductive material, such as heat sinks, and combinations thereof are contemplated within the spirit and scope of the present invention.

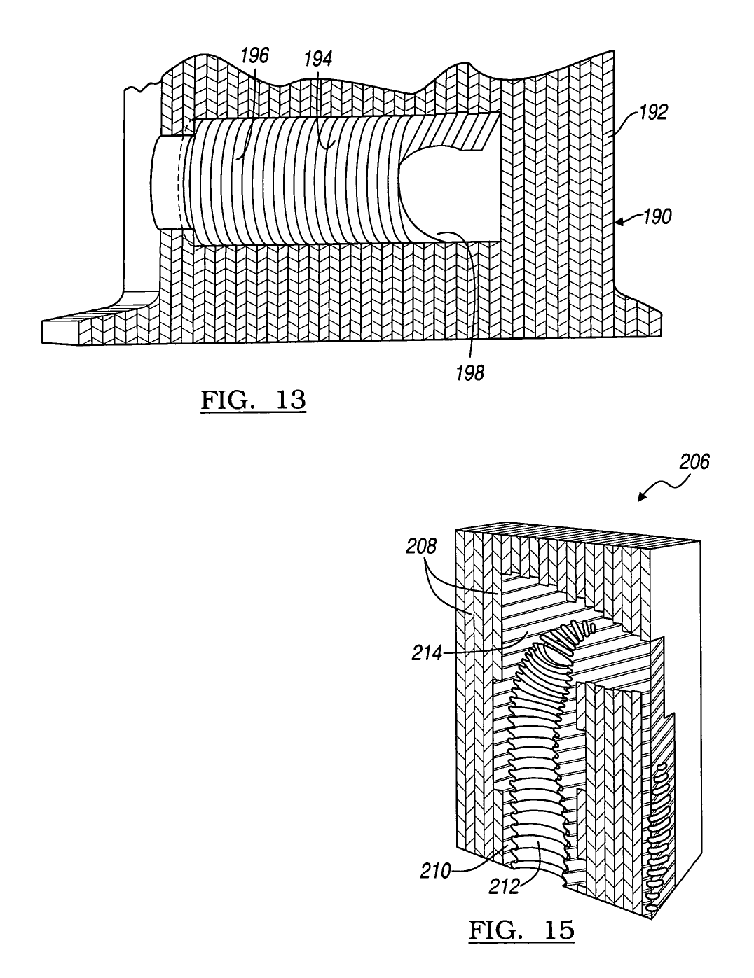

With reference now to FIG. 13, a perspective view of a sectioned tool 190 is illustrated in accordance with the present invention. The tool 190 is illustrated as a tool formed from a series of laminate sheets 192 that are bonded together. The tool 190 is illustrated sectioned after the casting process. The tool 190 includes a duct 194 that is formed collectively by cutouts formed through the laminate sheets 190. The duct 194 includes a first segment 196 formed generally perpendicular to the sheets 192 of the tool 190. The duct 194 also includes a contoured segment 198 formed generally parallel with the laminate sheets 192, thus illustrating various conformal arrangements of ducts that may be provided within the spirit and scope of the present invention. No tube is illustrated in the embodiment of the tool 190 of FIG. 13. A particulate material such as sand may be provided in the duct 194 during the casting operation to maintain the integrity of the duct 194.

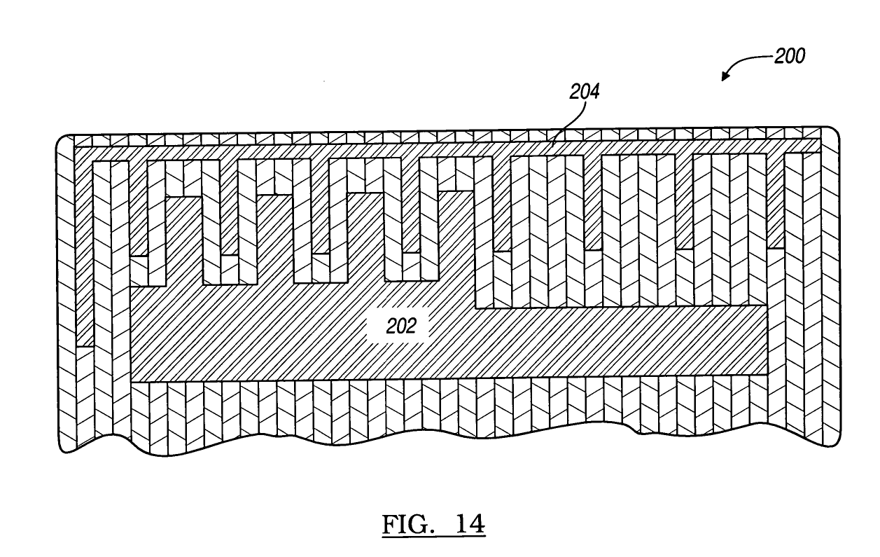

The invention also contemplates heat sinks of various complexities. With reference now to FIG. 14, another sectioned tool 200 is illustrated in accordance with the present invention. Heat sinks 202, 204 of varying geometries are provided throughout the tool body for providing a controlled heating or cooling of the tool 200 that is specific for the molding operation of the tool 200.

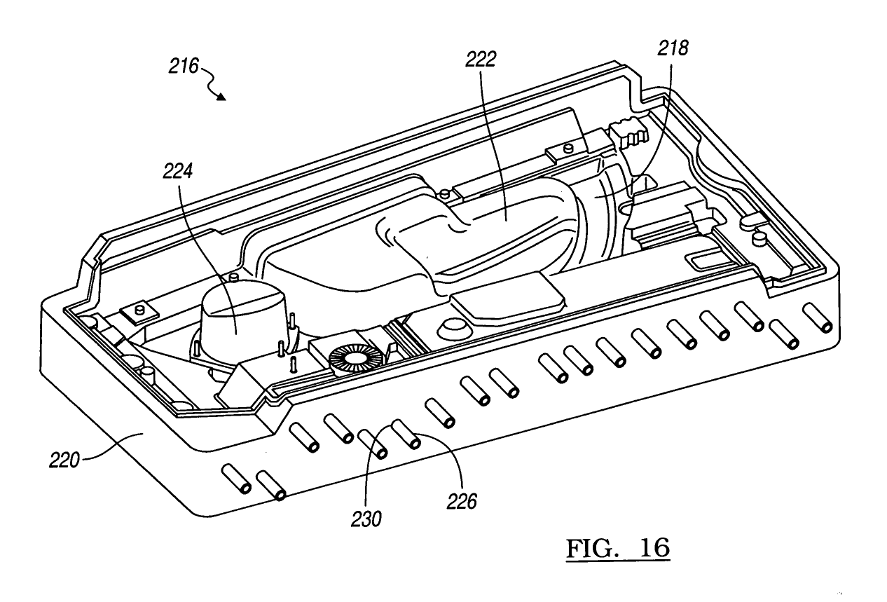

With reference now to FIG. 15, another sectioned or segmented tool 206 is illustrated formed from a plurality of laminate sheets 208 illustrating the complexities of ducting and heat sinks that may be provided in accordance with the present invention. A duct 210 is formed through the tool 206 and provided collectively by the plurality of laminate sheets 208. A corrugated tube 212 is provided within the duct for conveying fluid through the tool 206 for heating and cooling the tool 206. The duct 210 is filled with conductive material 214 for providing a heat sink for the tool 206 for heat transfer between the fluid and the tube 212 and a forming surface of the tool 206.

In FIG. 16, another tool 216 is illustrated in accordance with the present invention. The tool 216 depicted in FIG. 16 may be utilized, in one embodiment, with a corresponding mold half for collectively forming an interior door panel by a molding operation within an injection molding machine. The tool 216 may also be utilized alone for molding the door panel. The tool 216 may be formed from a laminate process or may be formed from a solid block that is machined. The tool 216 is illustrated with a forming surface 218 that is provided in a tool body 220, with appropriate contours for forming the article in the desired shape. For example, the forming surface 218 provides a mating face for a finished door panel with such door panel components as an armrest 222 and a speaker housing 224. The forming surface 218 may be a near net shape in the illustrated stage of manufacturing, for subsequent machining to a final forming surface.

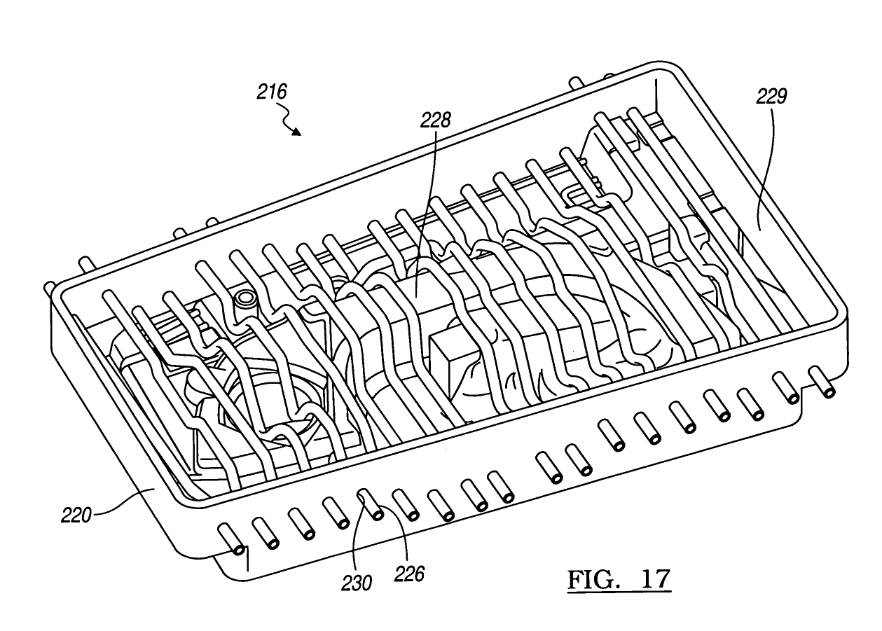

The tool body 220 is illustrated with a series of fluid lines 226 extending from the tool 216. As discussed with prior embodiments, the fluid lines 226 are employed for controlled heat transfer of the forming surface 218. Referring now to FIG. 17, a back side of the tool 216 is illustrated with a back surface 228 that is spaced apart from the forming surface 218. The back surface 228 may be spaced a desired thickness from the forming surface 218 for controlled heat transfer. In one embodiment, the back surface 228 is spaced uniformly from the forming surface 218 for uniform heat transfer between the forming surface 218 and the fluid lines 226. The back surface 228 may formed in the tool body 220 by machining; or a portion of the back surface 228 may be cut into each laminate sheet to collectively provide the back surface 228. The back surface 228 may also be provided within a cavity 229 in the tool body 220.

The fluid lines 226 are each shaped to be generally uniformly spaced apart from the back surface 228. The fluid lines may be formed from steel with a wall thickness of approximately 0.06 inches, which is adequate to withstand infiltration of a conductive material during the casting operation. Alternatively, flexible or corrugated tubing may be utilized as illustrated with prior embodiments. The fluid lines 226 may be contoured by manual cold forming processes, automated processes, or any suitable shaping process. Additionally the fluid lines 226 are adequately spaced relative to one another to suitably cool the or heat the forming surface 218. The fluid lines 226 may be supported by spacers, as in prior embodiments, or may be supported by apertures 230 that are formed in the tool body 220.

After the fluid lines 226 are assembled to the tool body 220, a heat sink material may be added to the back surface 228 in the cavity 229. The heat sink material may be cast into the cavity 229 as disclosed with prior embodiments for engagement with the back surface 228 and the fluid lines 226 for enhancing the rate of heat transfer between the forming surface 218 and the fluid lines 226. For example, the tool body 220 may be formed from stainless steel or aluminum and the heat sink material may provided from copper for conducting heat to and from the tool body 220 and the fluid lines 226.

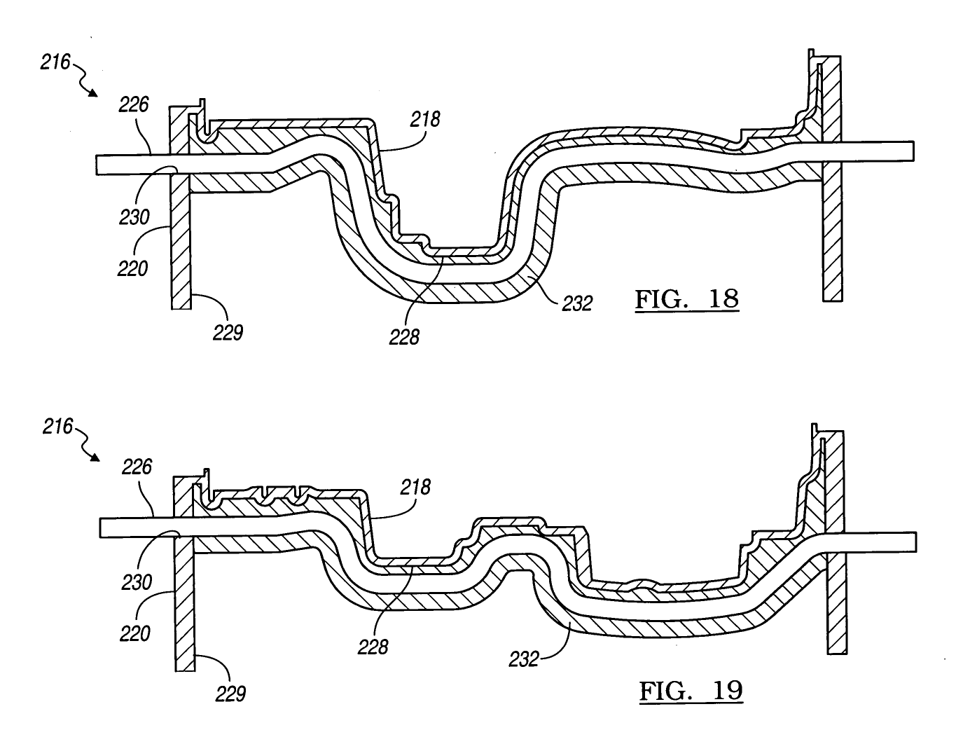

FIGS. 18 and 19 illustrate separate partial section views of the tool 216 taken through the tool body 220. Each view is illustrated adjacent one of the fluid lines 226. As illustrated, the tool body 220 is sized to adequately withstand the fatigues associated with the corresponding molding operation. The back surface 228 is spaced generally uniform from the forming surface 218 for adequately providing the surface characteristics required for the forming operation. The offset of the back surface 228 from the forming surface 218 is optimized for performing the molding operation while minimizing the conductive resistance provided by the tool body material.

FIGS. 18 and 19 illustrate examples of how the fluid lines 226 may be contoured relative to the corresponding back surface 228. The fluid lines 226 are encased within the heat sink material 232 due to the casting operation. The heat sink material 232 may be also conformed within the cavity 229 to the shape of the back surface 228 by ufilization of a tool body insert during the casting operation that is integrated into the tool body 220 or subsequently removed as illustrated.

Although various examples of tools with conductive materials, ducting and combinations thereof are provided herein, the invention contemplates various arrangements and combinations in accordance with the present invention. In summary, the present invention provides enhanced cooling and heating characteristics that are adaptable to the prescribed requirements for forming various articles thereby providing flexibility, improving quality and reducing cycle time to form the articles.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tool for forming an article in a molding operation comprising:
a tool body formed from a first material, the tool body having a forming surface for forming the article; and
a heat transfer material mounted to the tool body, spaced apart from the forming surface, the heat transfer material having a coefficient of thermal conductivity that is greater than that of the first material;
wherein the heat transfer material or the heat transfer material and the tool body collectively provide a duct for conveying a fluid for a transfer of heat with the forming surface through the tool body and the heat transfer material during a molding operation.

2. The tool of claim 1 further comprising at least one tube disposed within the duct for conveying the fluid.

3. The tool of claim 1 wherein the at least one tube further comprises a flexible tube.

4. The tool of claim 1 wherein the heat transfer material is provided with at least one separation formed therethrough for accommodating varying thermal expansion rates of the first material and the heat transfer material.

5. The tool of claim 1 wherein the heat transfer material is cast to the tool body.

6. The tool of claim 5 wherein a third material having a melting temperature greater than that of the heat transfer material is disposed in the duct prior to casting the heat transfer material for maintaining the duct as the heat transfer material is cast.

7. The tool of claim 6 wherein the third material further comprises sand.

8. The tool of claim 7 wherein the heat transfer material further comprises copper.

9. The tool of claim 8 wherein the first material further comprises a steel alloy.

10. The tool of claim 6 further comprising a mounting plate for the tool, the mounting plate being mounted to the tool body spaced apart from the forming surface;
wherein the heat transfer material is oriented upon the mounting plate and the tool is heated to a temperature greater than a melting temperature of the heat transfer material thereby causing the heat transfer material to melt and flow into the region between the mounting plate and the tool body.

11. The tool of claim 10 further comprising a plurality of supports extending from the tool body into engagement with the mounting plate for support of the tool body on the mounting plate.

12. The tool of claim 11 wherein one of the plurality of supports is fixed to the mounting plate and at least one of the plurality of supports is in translatable engagement with the mounting plate to accommodate varying thermal expansion rates of the tool body and the mounting plate.

13. A tool for forming an article in a molding operation comprising:
a tool body formed from a plurality of laminate sheets of a first material, the laminate sheets each being shaped to collectively form a forming surface for forming the article, and at least one of the plurality of laminate sheets being shaped to form a cavity in the tool body that is spaced apart from the forming surface; and
a heat transfer material having a coefficient of thermal conductivity greater than that of the first material, disposed within the cavity for a transfer of heat from the forming surface to the heat transfer material through the tool body during a molding operation.

14. The tool of claim 13 wherein a duct is formed in the tool body collectively by the laminate sheets for conveying a fluid, and the duct is in engagement with the heat transfer material for a transfer of heat between the forming surface and the fluid through the tool body and the heat transfer material during a molding operation.

15. The tool of claim 13 further comprising sidewalls formed to the tool body spaced apart from the forming surface;
wherein the heat transfer material is oriented upon the tool body within the sidewalls and the tool is heated to a temperature greater than a melting temperature of the heat transfer material thereby causing the heat transfer material to melt and flow into the cavity.

16. The tool of claim 13 further comprising sidewalls formed to the tool body spaced apart from the forming surface;
wherein the heat transfer material is oriented upon the tool body within the sidewalls and the tool is heated to a temperature greater than a melting temperature of the heat transfer material thereby causing the heat transfer material to melt and flow between adjacent laminate sheets and into the cavity, thereby brazing adjacent laminate sheets together and casting the heat transfer material into the cavity.

17. The tool of claim 13 wherein the heat transfer material has a melting temperature less than that of the first material, the heat transfer material being disposed between adjacent laminate sheets by placing the tool body in engagement with the heat transfer material and heating the tool to a temperature greater than the melting temperature of the heat transfer material so that the heat transfer material seeps between the adjacent laminate sheets through capillary action thereby brazing the adjacent laminate sheets of the tool body.

18. The tool of claim 17 further comprising sidewalls formed to the tool body spaced apart from the forming surface;
wherein the heat transfer material is oriented upon the tool body within the sidewalls when the tool is heated to the temperature greater than the melting temperature of the heat transfer material.

19. The tool of claim 17 wherein the tool is partially immersed within a third material having a melting temperature greater than that of the heat transfer material for bounding the tool while the tool is heated to the temperature greater than the melting temperature of the heat transfer material.

20. The tool of claim 19 wherein the third material is a refractory material that is cast about the tool.

21. The tool of claim 19 wherein the third material is an alumina-silicate carbide.

22. A method for forming a molding tool comprising:
providing a tool body from a first material with a forming surface for forming an article in a molding operation; and
casting a heat transfer region from a second material having a coefficient of thermal conductivity that is greater than that of the first material and a melting temperature less than that of the first material, to the tool body for a transfer of heat between the forming surface and the heat transfer region during a molding operation.

23. The method of claim 22 further comprising:
providing at least one tube on the tool body spaced apart from the forming surface; and
casting the heat transfer region to the tool body in engagement with the at least one tube for mounting the tube to the tool body for a transfer of heat between the forming surface and the tube through the tool body and the heat transfer region during a molding operation.

24. The method of claim 22 further comprising:
affixing a plate to the tool body;
orienting the second material upon the plate; and
heating the tool to a temperature greater than the melting temperature of the second material so that the second material melts and flows into engagement with the tool body.

25. The method of claim 22 further comprising:
affixing sidewalls to the tool body;
orienting the second material upon the tool body within the sidewalls; and
heating the tool to a temperature greater than the melting temperature of the second material so that the second material melts and flows into engagement with the tool body.

26. The method of claim 22 further comprising:
forming a duct within the tool body; and
casting the heat transfer region to the tool body and the duct for a transfer of heat between the forming surface and the duct through the tool body and the heat transfer region during a molding operation.

27. The method of claim 26 further comprising:
providing at least one tube in the duct prior to the casting process.

28. The method of claim 26 further comprising:
inserting a particulate material having a melting temperature greater than the melting temperature of the second material, into the duct prior to the casting of the heat transfer region.

29. A method for forming a molding tool comprising:
forming a tool body from a plurality of laminate sheets of a first material, to collectively form a forming surface for forming an article, and to collectively form a cavity in the tool body that is spaced apart from the forming surface; and
disposing a heat transfer material having a coefficient of thermal conductivity that is greater than that of the first material within the cavity for a transfer of heat between the forming surface and the heat transfer material through the tool body during a molding operation.

30. The method of claim 29 further comprising:
disposing a tube through the cavity in engagement with the heat transfer material for a transfer of heat between the forming surface and the tube through the tool body and the heat transfer material during a molding operation.

31. The method of claim 29 further comprising:
placing the tool body in engagement with a third material having a melting temperature less than that of the first material; and
heating the tool to a temperature greater than the melting temperature of the third material so that the third material seeps between adjacent laminate sheets through capillary action thereby brazing the adjacent laminate sheets of the tool body.

32. The method of claim 29 further comprising:
placing the tool body in engagement with a heat transfer material having a melting temperature less than that of the first material; and
heating the tool to a temperature greater than the melting temperature of the heat transfer material so that the heat transfer material seeps between adjacent laminate sheets through capillary action and flows into the cavity thereby brazing adjacent laminate sheets of the tool body and disposing the heat transfer material into the cavity.
